(19) United States
(12) Patent Application Publication
(10) Pub. No.: US 2020/0219346 A1
(43) Pub. Date: Jul. 9, 2020

(54) SMART FURNITURE

(71) Applicant: AKSHAYKUMAR SHAMSUNDAR DHANNAWAT, ELLICOTT CITY, MD (US)

(72) Inventor: AKSHAYKUMAR SHAMSUNDAR DHANNAWAT, ELLICOTT CITY, MD (US)

(21) Appl. No.: 16/271,364

(22) Filed: Feb. 8, 2019

Related U.S. Application Data
(60) Provisional application No. 62/790,063, filed on Jan. 9, 2019.

(51) Int. Cl. G07C 9/00; G08B 13/196

(52) U.S. Cl. CPC G07C 9/00563; G08B 13/19695

(57) ABSTRACT

A smart furniture comprises of compartments, door for opening/closing the compartment, lock (smart lock, digital or key lock) configured to lock/unlock the door, camera to capture footage, a motion sensor and a wireless communication interface configured to communicate real-time with remote computer, phone and tablets.

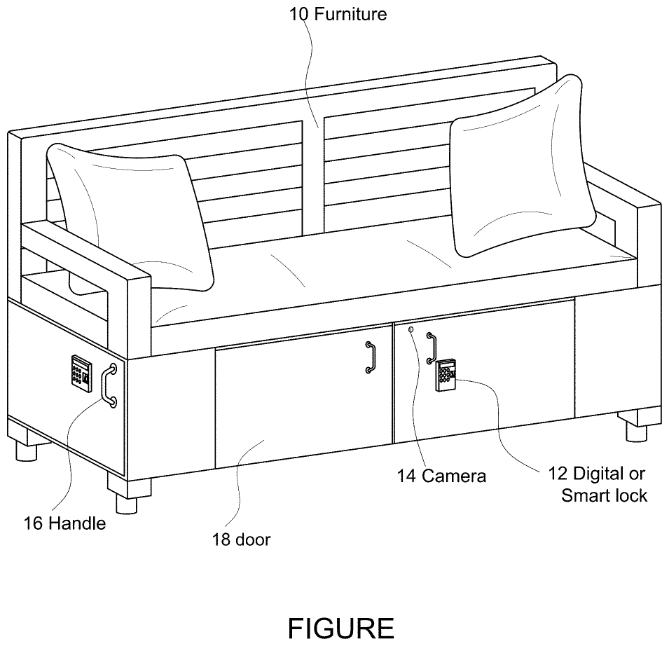

### BACKGROUND OF THE INVENTION

The present invention relates to furniture and, more particularly, to smart furniture used to keep valuables safe.

Mail (parcel) theft is very common since boxes/packages are delivered to front doors, porches and out in the open making it easier for the burglars. Further, in a Hotel/Resort/Vacation Rentals/Motel or even a Banquet Hall for instance does not provide a safe and secured place to hold valuables.

As can be seen, there is a need for a Smart Furniture with the latest technology and smart locks that can help stop mail Theft as well as store items secured and smartly.

### SUMMARY

The present invention called as the smart furniture offers a secure, safe and theft free delivery of mails and packages along with providing real-time notifications as people/delivery personnel come and go for secure-access around the clock. All deliveries can be monitored using a smart application. The smart furniture is also a smart way to secure items for Home/Hotel/Motel/Banquet halls/Rental facilities.

A smart furniture comprises of compartments, door for opening/closing the compartment, lock (smart lock, digital or key lock) configured to lock/unlock the door, camera to capture footage, a motion sensor and a wireless communication interface configured to communicate real-time with remote computer, phone and tablets.

Mail delivery person (FedEx, UPS, USPS, Amazon, DHL etc.) can place parcels inside the furniture and lock them using this invention. Additionally, the user can leave valuables locked inside the furniture at home, a hotel, a motel, a resort, and the like.

### BRIEF DESCRIPTION OF THE DRAWINGS

The FIGURE is a perspective view of an embodiment of the present invention.

### DETAILED DESCRIPTION OF THE INVENTION

The following detailed description is of the best currently contemplated modes of carrying out exemplary embodiments of the invention. The description is not to be taken in a limiting sense but is made merely for the purpose of illustrating the general principles of the invention, since the scope of the invention is best defined by the appended claims.

The present invention includes smart furniture that prevents theft of items. The furniture of the present invention may include any type of furniture like a chair, table, bench, sofa and ottoman with a lock (smart lock or regular lock or number/key lock) which prevents items from being stolen. The Mail delivery man (FedEx, UPS, USPS, Amazon, DHL etc.) can place parcels inside the furniture and lock them using the present invention. Additionally, the user can leave valuables locked inside the furniture at home, a hotel, a motel, a resort, and the like.

Referring now to the FIGURE, the present invention may include any type of furniture 10, such as a couch. The furniture 10 includes a compartment and doors 18 that either slide or swing open and closed. The doors 18 can be installed on any sides (top or from sides) of the furniture 10. The doors 18 can be auto-locked by simply closing the door 18. The doors 18 may include a lock 12. The lock 12 locks the door 18 in a closed position. The lock 12 may be a regular lock or a digital lock or smart lock 12. The doors 18 may be used as mailboxes or to keep valuable items within. The furniture 10 may further include a motion sensor, a camera 14, a wireless communications interface, and a processor for communication with a remote computer, phone and tablet.

In certain embodiments, the door 18 can be left open by default or can be opened with a PIN number. A deliveryman can drop the parcels (box/mails) inside of the compartment and close the door 18. The door lock 12 may automatically lock or manually lock by pressing a lock button or by shuffling lock numbers. A user may monitor the furniture 10 using an application on a smart device, such as a smart phone or tablet, or a computer, such as a laptop or desktop. When the parcel has been delivered, the motion sensor detects motion and the camera may be turned on to capture footage. A wireless signal is sent to the computer or phone or tablet, which notifies the user. Alternatively, the deliveryman may call the user to unlock the door and the user is able to unlock the door 18 using the application or the user may provide a temporary code.

The furniture of the present invention (Chair/Bench/Table/Sofa/Ottoman etc.) can be manufactured using any of the following combinations: (1) With smart lock; (2) With regular lock; (3) With key/digital lock; (4) With Camera; (5) With sensors; and with a wireless communications interface to communicate with a remote computer or phone or tablet. The furniture can be kept outside of the home for mail delivery. The furniture can be kept inside the home, a Motel, a Hotel, a resort etc. for safe storage. The furniture can be kept in the backyard or porch to keep valuables items safely.

It should be understood, of course, that the foregoing relates to exemplary embodiments of the invention and that modifications may be made without departing from the spirit and scope of the invention as set forth in the following claims.

What is claimed is:

1. A smart furniture comprising:
a compartment;
a door opening and closing the compartment;
a lock configured to lock the door in a closed position;
a camera to capture a plurality of images;
a sensor for detecting an object in a predefined proximity to the compartment; and
a wireless communication interface configured to communicate real-time with a remote computer.

2. The furniture of claim 1, wherein the compartment is positioned on one sides of the furniture.

3. The furniture of claim 1, wherein the door be positioned on one of the furniture, and wherein the door is selected from a group consisting of sliding door, regular door, folding door and pocket door.

4. The furniture of claim 1, wherein the lock is selected from a group consist of digital lock, smart lock and regular lock.

5. The furniture of claim 1, wherein the camera be installed to capture video images.

6. The furniture of claim 1, wherein the motion sensor is positioned in proximity to the camera.

7. The furniture of claim 1, wherein the wireless real-time communication interface with a remote computer (Computer, phone and tablet).

8. A smart chair comprising:
a compartment;
a door opening and closing the compartment;
a lock configured to lock the door in a closed position;
a camera to capture a plurality of images;
a sensor for detecting an object in a predefined proximity to the compartment; and
a wireless communication interface configured to communicate real-time with a remote computer.

9. The smart chair of claim 8, wherein the compartment is positioned on one sides of the chair.

10. The smart chair of claim 8, wherein the door be positioned on one of the chair, and wherein the door is selected from a group consisting of sliding door, regular door, folding door and pocket door.

11. The smart chair of claim 8, wherein the lock is selected from a group consist of digital lock, smart lock and regular lock.

12. The smart chair of claim 8, wherein the camera be installed to capture video images.

13. The smart chair of claim 8, wherein the motion sensor is positioned in proximity to the camera.

14. The smart chair of claim 8, wherein the wireless real-time communication interface with a remote computer (Computer, phone and tablet).

15. A smart table comprising:
a compartment;
a door opening and closing the compartment;
a lock configured to lock the door in a closed position;
a camera to capture a plurality of images;
a sensor for detecting an object in a predefined proximity to the compartment; and
a wireless communication interface configured to communicate real-time with a remote computer.

16. The smart table of claim 15, wherein the compartment is positioned on one sides of the smart table.

17. The smart table of claim 15, wherein the door be positioned on one of the smart table, and wherein the door is selected from a group consisting of sliding door, regular door, folding door and pocket door.

18. The smart table of claim 15, wherein the lock is selected from a group consist of digital lock, smart lock and regular lock.

19. The smart table of claim 15, wherein the camera be installed to capture video images.

20. The smart table of claim 15, wherein the motion sensor is positioned in proximity to the camera.

21. The smart table of claim 15, wherein the wireless real-time communication interface with a remote computer (Computer, phone and tablet).
